(19) United States
(12) Patent Application Publication
(10) Pub. No.: US 2009/0223464 A1
(43) Pub. Date: Sep. 10, 2009

(54) ANIMAL BATHING APPARATUS

(75) Inventor: Malcolm Dumenil, Hong Kong SAR (CN)

Correspondence Address: LEYDIG VOIT & MAYER, LTD, 700 THIRTEENTH ST. NW, SUITE 300, WASHINGTON, DC, 20005-3960, US

(73) Assignee: WINPORT TECHNOLOGY LIMITED, Hong Kong SAR (CN)

(21) Appl. No.: 12/042,623

(22) Filed: Mar. 5, 2008

(51) Int. Cl. A01K 13/00

(52) U.S. Cl. 119/676

(57) ABSTRACT

An apparatus for bathing an animal includes a tub supported in an elevated position upon a plurality of elongate legs. A tether includes at least one coupling for releasable connection to a fixture in the form of a slot in the rim of the tub to restrain movement of the animal. The coupling is received in the slot such that tension applied via a flexible member holds the coupling in engagement with the fixture throughout an angular range subtended between the flexible member and the fixture to restrain an animal that is within the tub. To avoid trauma to an animal leaping from the tub while tethered, a tensile load applied through the flexible member, when the animal is suspended by the tether assembly outside the tub, separates the coupling and fixture to release the animal.

### TECHNICAL FIELD

The present invention relates to apparatus for enabling a pet owner to bathe a small animal, such as a dog or cat.

### BACKGROUND OF THE INVENTION

Many pet owners struggle greatly when bathing small pets. Dogs submit reluctantly to being bathed and frequently try to escape. Controlling a dog during a wash can require constant vigilance and, to avoid bending down, this strenuous task is most conveniently performed using an elevated tub.

Various neck restraints have been used for immobilising animals, however the somewhat restricted access for washing may cause problems in this application. Moreover, the cost and complexity of such devices means that they would have limited application outside of a professional grooming facility.

An example of apparatus better suited for home use is described in U.S. Pat. No. 5,974,601, and includes a tub which may be supported in an elevated position by removable folding legs. A short tether fixed at a longitudinal end to the rim of the tub restrains the animal's movements. Advantageously, dogs are familiar with being restrained in this way, either with a neck collar, or a shoulder harness. However with such a tether, a dog that leaps out of the tub may pull the tub to the floor, or else is held hanging from the tub, and either outcome could traumatise or injure the animal. One solution to this problem is to provide a high fence around the periphery of the tub, but this restricts access for washing and substantially increases the size and cost of the apparatus.

Additionally, prior art apparatus for bathing pets, including that taught by the above-mentioned patent, have not satisfactorily addressed the problems associated with their storage. Particularly for domestic use, units require disassembly for storage and suffer from the drawback that essential components may become separated or misplaced, a problem that increases with the number of parts

It is an object of the present invention to overcome or substantially ameliorate the above disadvantages or, more generally, to provide an improved animal bathing apparatus.

### DISCLOSURE OF THE INVENTION

According to one aspect of the invention there is provided apparatus for bathing an animal including:

a tub having a bottom and a peripheral wall integrally attached to and extending upwardly from the bottom;

the peripheral wall having an outermost rim;

a plurality of leg-receiving apertures;

a plurality of elongate legs, each adapted to be received and removably retained in a respective one of the apertures for supporting the tub upright in an elevated position;

a tether assembly for engaging a fixture on the tub to restrain movement of the animal, the tether assembly including at least one coupling for releasable connection to the fixture, and a flexible member connecting the coupling to the animal, whereby the coupling and fixture cooperate such that tension applied through the flexible member holds the coupling in engagement with the fixture within an angular range subtended between the flexible member and the fixture to restrain an animal that is within the tub and a tensile load applied through the flexible member when the animal is suspended by the tether assembly outside the tub separates the coupling and fixture so as to release the animal.

The angular range provides restraint for animals of different sizes at different positions within the tub. The tensile load required to release the suspended animal is small to provide reliable release and to avoid trauma to a tethered animal which leaps from the tub. The release is therefore substantially dependent upon the direction of loading, rather than the magnitude of the loading. Drawbacks associated with the release being dependent upon the magnitude of the loading, such as the need to provide means to vary the release load in proportion to the mass of the animal, are thereby avoided.

Preferably each fixture comprises a slot provided at or adjacent the rim for ready access and the at least one coupling includes a neck part adapted to be slidingly received in the slot, and a head part fixed to the neck part for retaining the coupling in the slot. Those skilled in the art will appreciate that the release dependent upon the direction of loading could be provided in a number of other alternative ways. For instance, the fixture may include locking elements such as a pivoting jaw engaging the coupling so that the tension applied through the flexible member holds the jaw closed when the animal is within the tub and the change in direction, when the animal is outside the tub, acts to open the jaw and release the coupling.

Preferably the tub includes a re-entrant lip outwardly spaced from and integral with the peripheral wall and the fixture includes a slot extending generally transversely to the lip, the slot having an inner portion adjacent a closed end of the slot and separated from a mouth portion of the slot by a waist portion, the at least one coupling includes a neck part adapted to be slidingly received in the slot, and a head part fixed to the neck part for retaining the coupling in the slot, whereby the neck part may be pushed past the waist portion to retain the neck part in the inner portion.

The tether assembly preferably further includes a fastener fixed to the flexible member for releasable fastening to a neck collar or harness of the animal and fittings for adjusting the length of the flexible member to accommodate animals of differing sizes. Optionally the tether assembly may further include a neck collar or shoulder harness.

Preferably the inner portion of the slot is provided in the rim.

Preferably the tub is elongate, the peripheral wall including opposing end walls separated by longitudinally-extending side walls,

the tether assembly includes first and second couplings joined by the flexible member to the fastener,

the tub includes first and second fixtures either side of an imaginary upright longitudinally-extending plane, whereby

the first and second couplings cooperate with respective ones of the first and second fixtures such that tension applied through the flexible member is resisted by each fixture within respective first and second angular ranges subtended between the flexible member and each fixture to restrain an animal that is within the tub, and a tensile load applied through the flexible member when the animal is suspended by the tether assembly outside the tub separates the each coupling and fixture so as to release the animal.

Preferably each of the first and second fixtures includes a slot extending generally transversely to the lip, each slot having an inner portion adjacent a closed end of the slot and separated from a mouth portion of the slot by a waist portion, each coupling includes a neck part adapted to be slidingly received in the slot, and a head part fixed to the neck part for retaining the coupling in the slot, whereby the neck part may be pushed past the waist portion to retain the neck part in the inner portion.

Preferably recesses are disposed in opposing portions of the rim, the recesses being aligned in pairs, a recess of each pair configured to receive one of the legs, each recess having a narrow throat section for retaining the legs by a snap action. Thus, after use when the apparatus disassembled for storage the legs are fastened to the tub, avoiding the possibility of them becoming separated and misplaced.

Preferably the tub further includes a reinforcing rib in each corner, the rib being laterally positioned between the lip and peripheral wall, extending downwardly from the rim, with longitudinal ends of the rib blending tangentially into the lip.

The apparatus preferably further includes at least one upwardly-opening pocket in the tub for holding bathing accessories. Preferably at least one channel is also provided for receiving a spray wand.

### BRIEF DESCRIPTION OF THE DRAWINGS

Preferred forms of the present invention will now be described by way of example with reference to the accompanying drawings, wherein:

FIG. 1 is a perspective view of apparatus of the invention assembled for bathing an animal;

FIG. 2 is an end view of the apparatus if FIG. 1 shown collapsed for storage;

FIG. 3 is a view of detail A of FIG. 2;

FIG. 4 is a fragmentary pictorial view of a fixture detail of the apparatus of FIG. 1;

FIG. 5 is a pictorial view of the tether assembly of the apparatus of FIG. 1;

FIG. 6 is a fragmentary pictorial view of a spray wand-receiving recess of the apparatus of FIG. 1;

FIG. 7 is an orthogonal view from below of a corner of the apparatus of FIG. 1;

FIG. 8 is an end elevation of the tub of the apparatus of FIG. 1, and

FIG. 9 is a fragmentary side elevation of the tub of the apparatus of FIG. 1.

### DESCRIPTION OF THE PREFERRED EMBODIMENTS

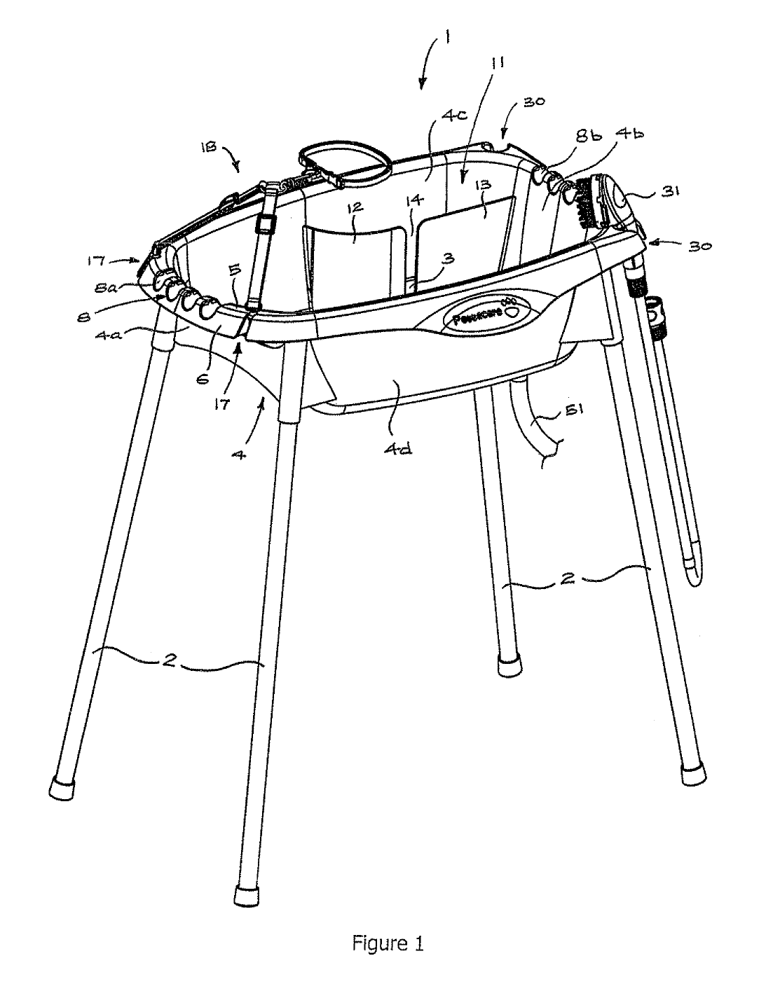

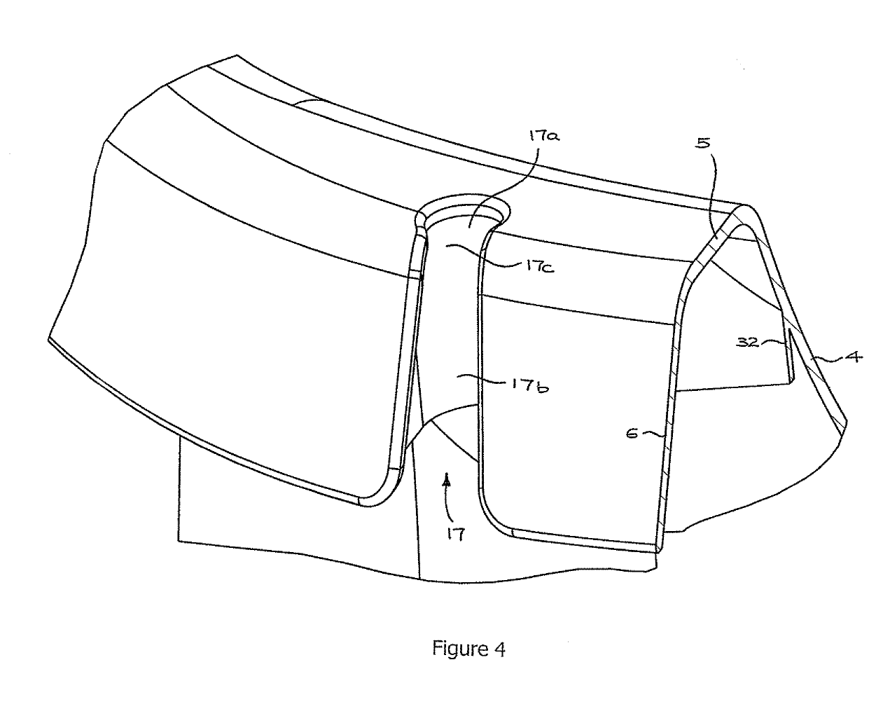

Referring to FIGS. 1-3, apparatus for bathing a small animal such as a dog, includes a one-piece moulded polymeric tub 1 supported upright in an elevated position upon four elongate tubular legs 2. The tub 1 includes a bottom 3 and a peripheral wall 4 integrally attached to and extending upwardly from the bottom 3. The tub 1 is elongate, the peripheral wall 4 including opposing end walls 4a, 4b separated by longitudinally-extending side walls 4c, 4d. The peripheral wall 4 has an outermost rim 5 lying generally in a horizontal plane and a re-entrant lip 6 outwardly spaced from and integral with the peripheral wall 4.

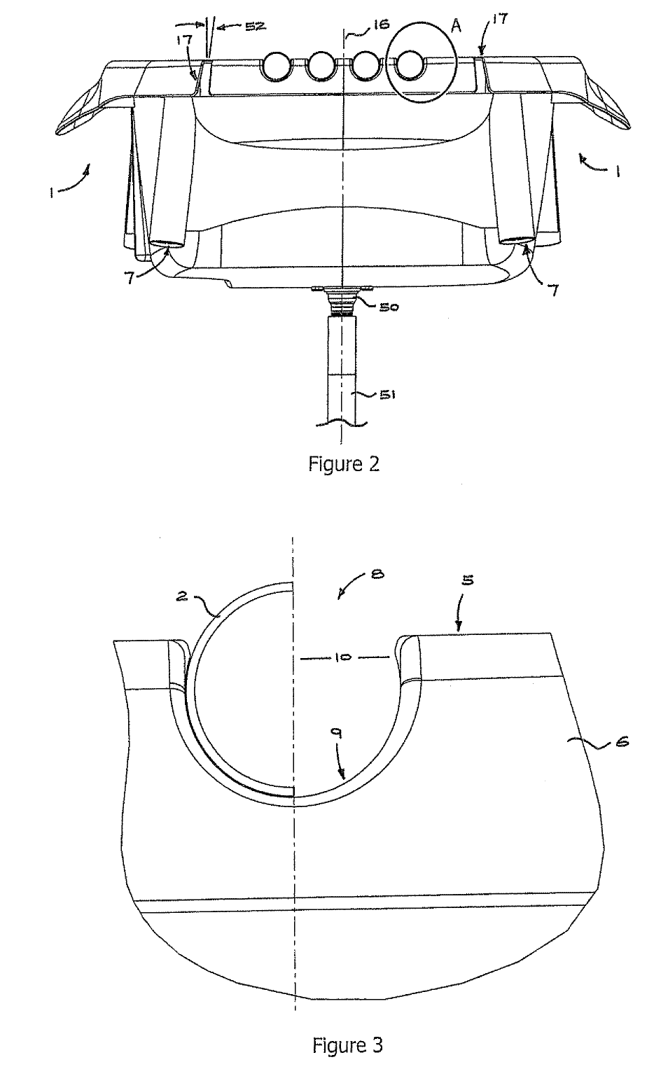

Recesses 8 with partly-cylindrical faces 9 are disposed in longitudinally opposing portions of the rim 5 and aligned in four pairs 8a, 8b. The recesses 8a, 8b of each pair are coaxial to receive one of the legs 2 when the apparatus is disassembled for storage as shown in FIG. 2. At the outermost side of the recesses 8 is a narrow throat 10 through which the legs 2 must pass into the recess 8, and the resilience of the material retains the legs by a snap action. Thus, after use the legs 2 are fastened to the tub 1 in this manner to avoid the possibility of them becoming separated and misplaced. Downwardly-opening apertures 7 adjacent the corners of the tub, are provided for receiving the legs 2. Detents (not shown) are provided for holding the legs 2 in the aperture 7.

A pocket 11 for holding bathing accessories, such as soap, shampoo and brushes, is formed between two substantially upright integral panels 12, 13 and the adjacent walls 4b, 4c. A narrow gap 14 between the panels 12, 13 extends to the bottom 3 for drainage of the pocket 11.

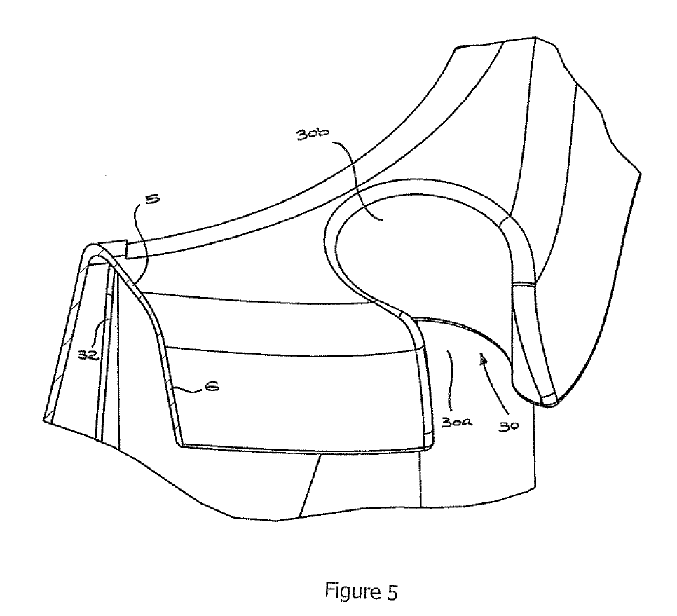

Adjacent the corners joining the side walls 4c, 4d and the end wall 4a, either side of an imaginary upright longitudinally-extending plane 16, are fixtures in the form of slots 17. As best seen in FIG. 4, each slot 17 has an inner portion 17a formed in the rim 5 adjacent a closed end of the slot 17. A mouth portion 17b of the slot is separated by a waist portion 17c from the inner portion 17a. The elongate, tapered mouth portions 17b extend generally transversely to the lip 6 but each diverges slightly, their respective longitudinal axes being inclined at an angle 52 of around 3 degrees to the plane 16.

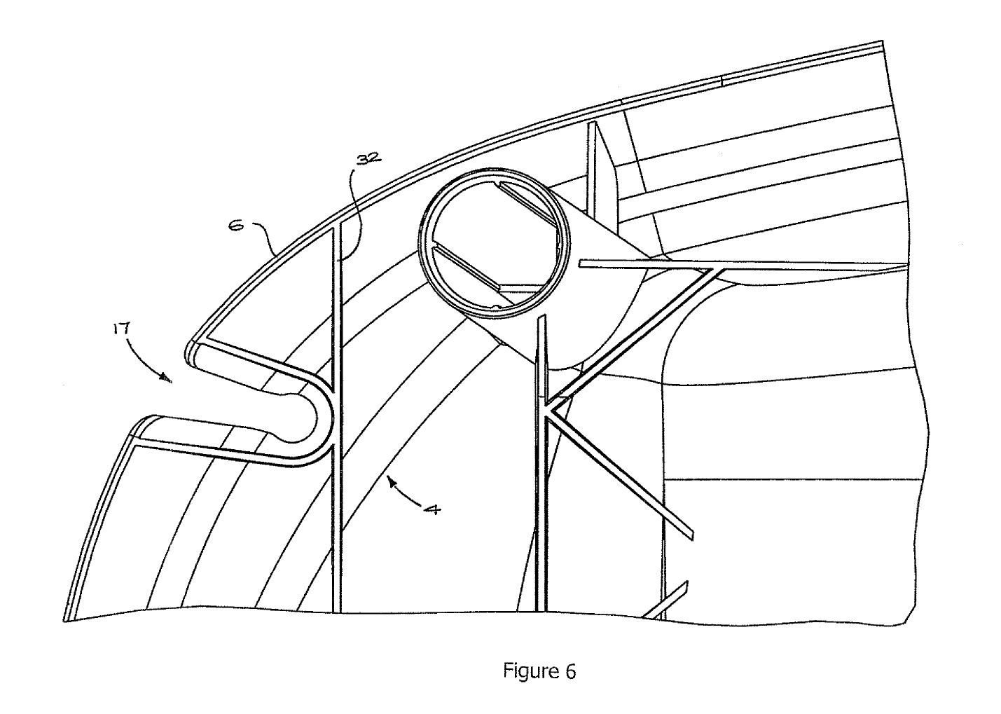

Shown in detail in FIG. 5, at the opposite end from the slots 17, either side of the plane 16 are recesses 30 for receiving a spray wand 31. Like the slots 17, the recesses 30 extend from a mouth opening 30a in the lip 6 to a closed end 30b in the rim 5.

To avoid the discontinuities in the lip 6 caused by the recesses 30 and slots 17 from reducing the stiffness of the tub 1, a reinforcing rib 32 is provided in each corner of the tub, as shown in FIGS. 4 to 6. The rib 32 is laterally positioned between the lip 6 and peripheral wall 4, extending downwardly from the rim 5. The longitudinal ends of the rib 32 blend tangentially into the lip 6 and the rib 32 is spaced apart from the lip 6 sufficiently to receive the head 27.

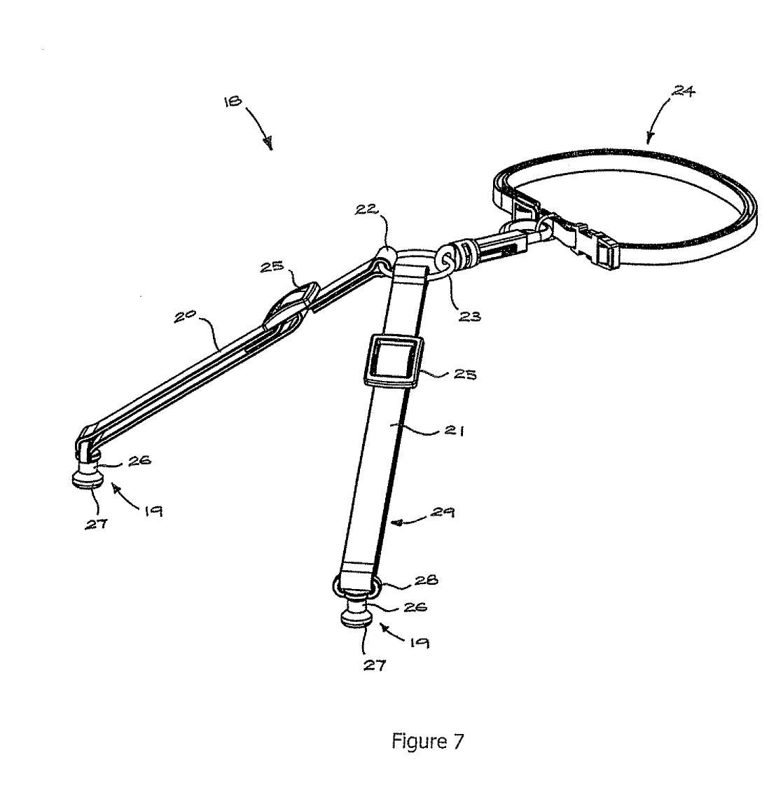

FIG. 7 illustrates a tether assembly 18 for engaging the fixture 15 to restrain movement of the animal. The tether assembly 18 includes two couplings 19 for releasable connection to respective fixtures 16. The couplings 19 are fastened by a flexible member comprising straps 20, 21 to a fastener 22 for releasable fastening to ring 23 fixed to a neck collar 24. The length of the straps 20, 21 are individually adjustable by means of buckles 25 to accommodate animals of differing sizes. Each coupling 19 includes a neck part 26 adapted to be slidingly received in the slot 17, and an enlarged head part 27 formed on the end of the neck part 26. An elongate opening 28 receives a loop 29 in the end of each strap 20, 21. Each of the fixtures 15 includes slot 17 extending generally transversely to the lip 6. The slot 17 has an inner portion 17a formed in the rim 5 adjacent a closed end of the slot 17. A mouth portion 17b of the slot is separated by a waist portion 17c from the inner portion 17a.

A drain 50 is provided in the lowest part of the bottom 3 and an elongate hose 51 is connected to the drain 50.

In use, the legs 2 are secured in the aperture 7 and the couplings 19 connected to the slots 17. The neck part 26 of each coupling 19 is pushed into the slot 17, past the waist portion 17c into the inner portion 17a, where the resilience of the material provides a snap-type connection for retaining the coupling. The hose is run to a waste, such as in a bath or shower. A collar 24 (or a harness—not shown) is secured about the animal's neck and the animal is allowed to stand upon the bottom of the tub, with its head adjacent the end wall 4a. The animal is then tethered to the bath 1 by engaging the fastener 22 with the ring 23. The length of the straps 20, 21 may be adjusted, such that with the animal standing normally, each strap 20, 21 generally subtends a straight line between the ring and the slot 17.

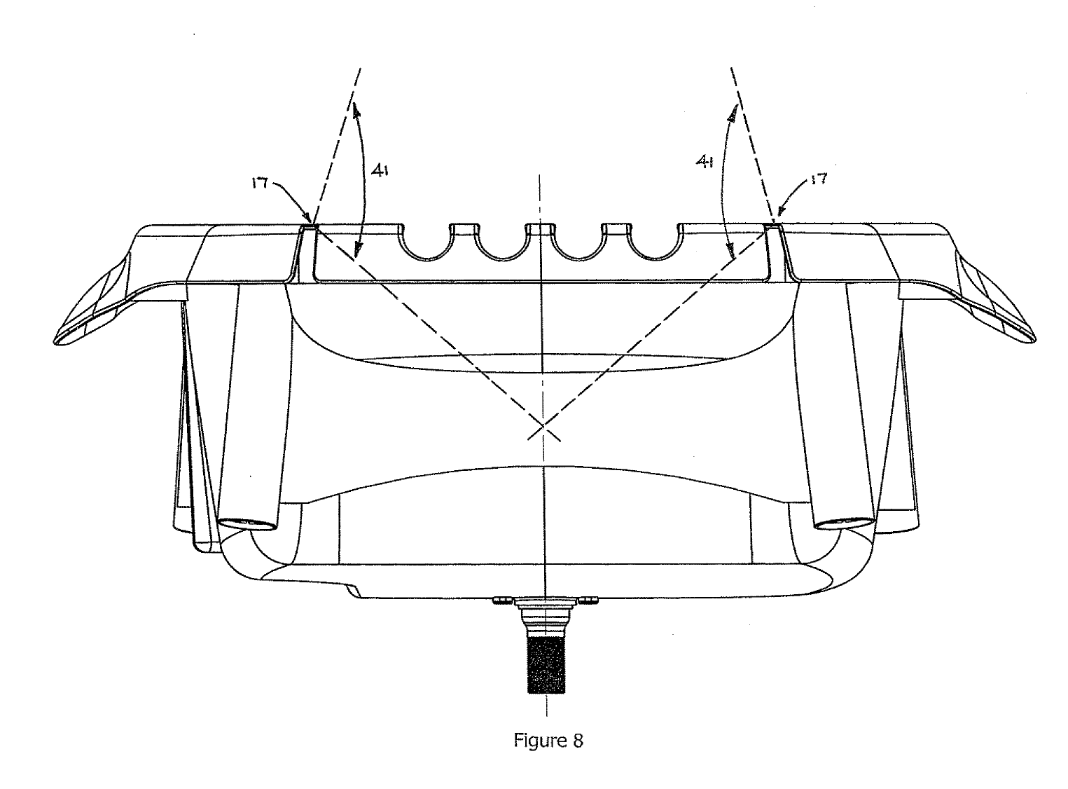

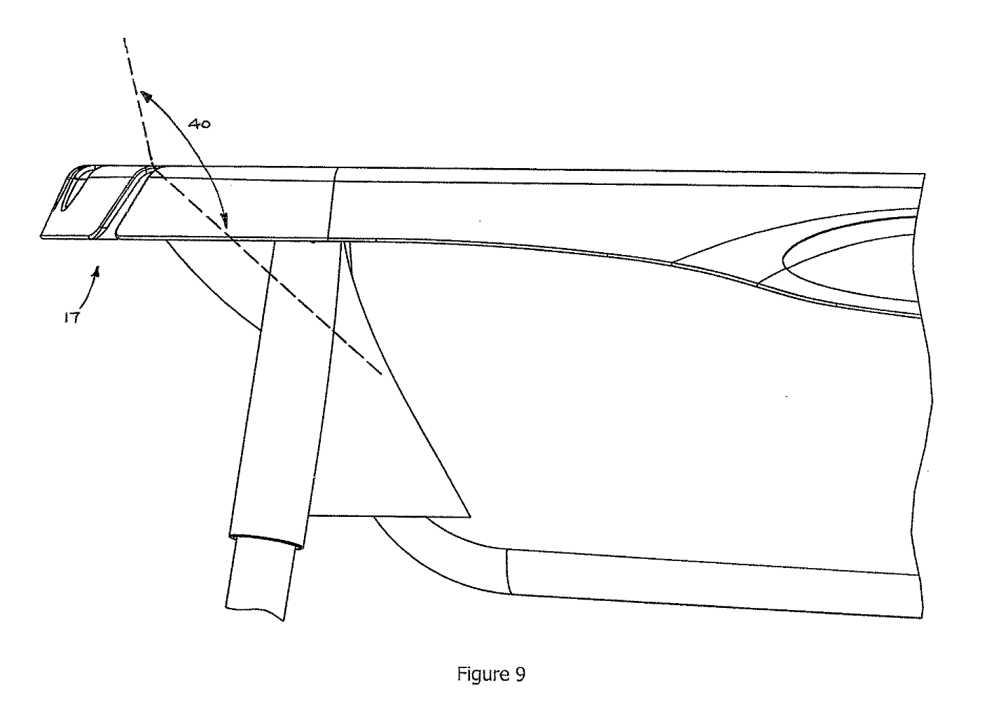

An angular range subtended between the respective flexible strap 20, 21 and the slot 17 varies depending upon the size and position of the animal and the placement of the attachment point to the animal. As seen in FIGS. 8 and 9, this angular range has a component 40 measured in the plane 16 and a component 41 measured in an upright plane orthogonal to plane 16.

An animal tethered in this way cannot escape from the tub 1 over the side walls 4c, 4d, but it may be able to leaps forward over the end wall 4a. In this event, the tension applied through the straps 20, 21 as they are angled downward outward of the rim 5 beyond the angular range 40, 41 serves to separate both couplings 19 from their respective slots 17 so as to release the animal. The stiffness of the material and dimension of waist portion 17c are chosen such than any animal large enough to require restraint to avoid it escaping the tub 1 has sufficient weight to release the coupling from the slot 17 when the animal is suspended by the tether assembly outside the tub. This avoids the animal being held hanging from the tub or pulling the tub to the floor.

Aspects of the present invention have been described by way of example only and it should be appreciated that modifications and additions may be made thereto without departing from the scope thereof.

1. An apparatus for bathing an animal including:
a tub having
a bottom and a peripheral wall integrally attached to and extending upwardly from the bottom; the peripheral wall having an outermost rim; and
a plurality of leg-receiving apertures;
a plurality of elongate legs, each leg being adapted to be received and removably retained in a respective one of the apertures for supporting the tub upright in an elevated position;
a tether assembly for engaging a fixture on the tub to restrain movement of the animal, the tether assembly including at least one coupling for releasable connection to the fixture and a flexible member connecting the coupling to the animal, wherein
the coupling and the fixture cooperate such that tension applied through the flexible member holds the coupling in engagement with the fixture within an angular range subtended between the flexible member and the fixture to restrain the animal when within the tub and
a tensile load applied through the flexible member when the animal is suspended by the tether assembly outside the tub separates the coupling and fixture to release the animal.

2. The apparatus of claim 1 wherein
each fixture comprises a slot located at or adjacent the rim for ready access, and
the at least one coupling includes a neck part slidingly received in the slot, and a head part fixed to the neck part for retaining the coupling in the slot.

3. The apparatus of claim 1 wherein
the tub includes a re-entrant lip outwardly spaced from and integral with the peripheral wall,
the fixture includes a slot extending generally transversely to the lip,
the slot has an inner portion adjacent a closed end of the slot and separated from a mouth portion of the slot by a waist portion, and
the at least one coupling includes a neck part slidingly received in the slot, and a head part fixed to the neck part for retaining the coupling in the slot, so that the neck part may be pushed past the waist portion to retain the neck part in the inner portion.

4. The apparatus of claim 1 wherein the tether assembly further includes
a fastener fixed to the flexible member for releasable fastening to a neck collar or harness of the animal, and
fittings for adjusting length of the flexible member to accommodate animals of differing sizes.

5. The apparatus of claim 3 wherein the inner portion of the slot is located in the rim.

6. The apparatus of claim 1 wherein
the tub is elongate and the peripheral wall includes opposing end walls separated by longitudinally-extending side walls,
the tether assembly includes first and second couplings joined by the flexible member to a fastener, and
the tub includes first and second fixtures on opposite sides of an imaginary upright longitudinally-extending plane, wherein
the first and second couplings cooperate with respective ones of the first and second fixtures such that tension applied through the flexible member is resisted by each fixture within respective first and second angular ranges subtended between the flexible member and each fixture to restrain an animal that is within the tub, and
tension applied through the flexible member outside the angular ranges separates the coupling and each fixture to release the animal.

7. The apparatus of claim 6 wherein
each of the first and second fixtures includes a slot extending generally transversely to the lip,
each slot has an inner portion adjacent a closed end of the slot and separated from a mouth portion of the slot by a waist portion, and
each coupling includes a neck part slidingly received in the slot, and a head part fixed to the neck part for retaining the coupling in the slot, wherein the neck part may be pushed past the waist portion to retain the neck part in the inner portion.

8. The apparatus of claim 1 including recesses disposed in opposing portions of the rim, wherein the recesses are aligned in pairs, a recess of each pair is configured to receive one of the legs, and each recess has a narrow throat section for retaining a leg by a snap action.

9. The apparatus of claim 1 wherein the tub further includes a reinforcing rib in each corner, the rib being laterally positioned between the lip and the peripheral wall, extending downwardly from the rim, with longitudinal ends of the rib blending tangentially into the lip.

10. The apparatus of claim 9 further including at least one upwardly-opening pocket in the tub for holding bathing accessories.
